(19) United States
(12) Patent Application Publication
(10) Pub. No.: US 2025/0347811 A1
(43) Pub. Date: Nov. 13, 2025

(54) LIGHT DETECTION AND RANGING SYSTEM

(71) Applicant: LightIC Technologies HK Limited, Hong Kong (CN)

(72) Inventors: Guomin JIANG, Santa Clara, CA (US); Tianbo SUN, Santa Clara, CA (US); Jie SUN, Santa Clara, CA (US)

(21) Appl. No.: 18/595,974

(22) Filed: Mar. 5, 2024

(51) Int. Cl. G01S 17/34; G01S 7/481

(52) U.S. Cl. CPC G01S 17/34; G01S 7/4811; G01S 7/4815; G01S 7/4817

(57) ABSTRACT

A light detection and ranging system is provided. The system includes: a laser unit configured to emit a first signal laser and/or a second signal laser which are frequency modulated lasers, the first signal laser has an ascending-frequency duration, the second signal laser has a descending-frequency duration, wherein wavelengths or polarization directions of the first signal laser and the second signal laser are different, and an angle scanning compensator configured to receive the first signal laser and the second signal laser in a time-division manner, and to emit the first signal laser and the second signal laser in a substantially same direction.

### TECHNICAL FIELD

The present application relates to the technical field of light detection and ranging systems, specifically, relates to a light detection and ranging system.

### BACKGROUND

A light detection and ranging system is a radar system that emits a laser beam to detect characteristics such as a position and a speed of a target. An operational principle of the light detection and ranging system is to transmit a detection signal to the target, then receive a signal reflected from the target, and compare the received signal with the transmitted signal. After appropriate processing is made, relevant information about the target can be obtained, such as a distance, orientation, an altitude, a speed, attitude, even shape and other parameters, thereby detecting, tracking and identifying aircraft, missiles and other targets. The light detection and ranging system is now widely deployed in different scenarios including autonomous vehicles. The light detection and ranging system can actively estimate the distance and the speed of environmental features when scanning a scenario, and generate a point position cloud indicating a three-dimensional shape of an environmental scenario.

### SUMMARY

A light detection and ranging system is provided. The system includes: at least one laser transmission and detection channel, wherein each of the at least one laser transmission and detection channel includes:
a laser unit configured to emit a first signal laser and/or a second signal laser, the first signal laser and the second signal laser are frequency modulated lasers, the first signal laser has an ascending-frequency duration, and the second signal laser has a descending-frequency duration, wherein a wavelength of the first signal laser is different from a wavelength of the second signal laser, or a polarization direction of the first signal laser is different from a polarization direction of the second signal laser;
a light emitter configured to emit the first signal laser and/or the second signal laser;
an angle scanning compensator configured to receive the first signal laser and the second signal laser from the light emitter in a time-division manner, and to emit the first signal laser and the second signal laser in a substantially same direction, wherein the first signal laser and the second signal laser are reflected after encountering a target, to generate a first reflected laser and a second reflected laser;
a detection component configured to receive the first reflected laser and the second reflected laser, obtain a first beat frequency signal of the first reflected laser and a second beat frequency signal of the second reflected laser, and output the first beat frequency signal and the second beat frequency signal; and
an acquisition and processing device configured to determine a speed and/or a distance of the target based on the first beat frequency signal and the second beat frequency signal.

Optionally, the angle scanning compensator includes a dispersion device, and the wavelength of the first signal laser is different from the wavelength of the second signal laser; or the angle scanning compensator includes a birefringent device, and the polarization direction of the first signal laser is different from the polarization direction of the second signal laser.

Optionally, the angle scanning compensator includes a rotating mirror; the dispersion device or the birefringence device enables the first signal laser and the second signal laser to be incident onto the rotating mirror with a first angular deviation, and the rotating mirror enables the first signal laser and the second signal laser be emitted in the substantially same direction, or the rotating mirror reflects the first signal laser and the second signal laser onto the dispersion device or the birefringence device with a first angle deviation, and the dispersion device or the birefringence device enables the first signal laser and the second signal laser to be emitted in the substantially same direction.

Optionally, the light emitter includes a first polarization-rotation optical splitter or a circulator.

Optionally, the laser unit includes: a first laser configured to generate a first laser beam having a first wavelength; and a second laser configured to generate a second laser beam having a second wavelength.

Optionally, the laser unit further includes: a first optical switch configured to receive the first laser beam and selectively pass or block the first laser beam; a second optical switch configured to receive the second laser beam and selectively pass or block the second laser beam; a first multiplexer, connected to the first optical switch and the second optical switch, and configured to multiplex the first laser beam and the second laser beam, and output the first laser beam and the second laser beam in a time-division manner.

Optionally, the laser unit further includes:
a first optical splitter configured to receive the first laser beam and the second laser beam, split the first laser beam into a first component of the first laser beam and a second component of the first laser beam, and split the second laser beam into a first component of the second laser beam and a second component of the second laser beam,
a first phase shifter and a second phase shifter, wherein the first phase shifter is configured to receive the first component of the first laser beam and the first component of the second laser beam, and perform phase-shift of the first component of the first laser beam and the first component of the second laser beam, and the second phase shifter is configured to receive the second component of the first laser beam and the second component of the second laser beam and perform phase-shift of the second component of the first laser beam and the second component of the second laser beam, so that phase difference between the phase-shifted first component of the first laser beam and the phase-shifted second component of the first laser beam is 0 degree and phase difference between the phase-shifted first component of the second laser beam and the phase-shifted second component of the second laser beam is 180 degrees, or the phase difference between the phase-shifted first component of the first laser beam and the phase-shifted second component of the first laser beam is 180 degrees and the phase difference between the phase-shifted first component of the second laser beam and the phase-shifted second component of the second laser beam is 0 degree;
a first combiner configured to receive the phase-shifted first component of the first laser beam and the phase-shifted first component of the second laser beam, and to receive the phase-shifted second component of the first laser beam and the phase-shifted second component of the second laser, wherein when the phase difference between the phase-shifted first component of the first laser beam and the phase-shifted second component of the first laser beam is 0 degree and the phase difference between the phase-shifted first component of the second laser beam and the phase-shifted second component of the second laser beam is 180 degrees, the first combiner outputs the first laser beam; when the phase difference of the phase-shifted first component of the first laser beam and the phase-shifted second component of the first laser beam is 180 degrees and the phase difference between the phase-shifted first component of the second laser beam and the phase-shifted second component of the second laser beam is 0 degree, the first combiner outputs the second laser beam.

Optionally, each of the at least one laser transmission and detection channel further includes: a second optical splitter configured to receive the first laser beam and the second laser beam in a time-division manner, divide the first laser beam into a first signal laser and a first local oscillation laser, and divide the second laser beam into a second signal laser and a second local oscillation laser.

Optionally, the laser unit includes:
a first laser configured to generate a first laser beam having a first wavelength;
a third optical splitter configured to receive the first laser beam and divide the first laser beam into a first laser component and a second laser component,
a first phase shifter configured to receive the first laser component and perform phase-shift of the first laser component;
a second phase shifter configured to receive the second laser component, and perform phase-shift of the second laser component, so that phase difference between the first laser component and the second laser component is 90 degrees or −90 degrees;
a first optical splitter configured to receive the phase-shifted first laser component and the phase-shifted second laser component, and output a first combined laser or a second combined laser, wherein when phase difference between the phase-shifted second laser component and the phase-shifted second laser component is 90 degrees, the first optical splitter outputs the first combined laser; when phase between the phase-shifted first laser component and the phase-shifted second laser component is-90 degrees, the first optical splitter outputs the second combined laser.

Optionally, each of the at least one laser transmission and detection channel further includes: a second polarization-rotation optical splitter configured to maintain a polarization direction of the first combined laser, change a polarization direction of the second combined laser, and output the first combined laser with the polarization direction being unchanged and the second combined laser with the polarization direction being changed.

Optionally, each of the at least one laser transmission and detection channel further includes:
a fourth optical splitter, arranged at a light emission end of the second polarization-rotation optical splitter, and configured to divide the first combined laser into a first signal laser and a first local oscillation laser, or to divide the second combined laser into a second signal laser and a second local oscillation laser.

Optionally, the detection component includes: a first mixer configured to receive the reflected laser beam and the first local oscillation laser, or to receive the reflected laser beam and the second local oscillation laser, and to mix the reflected laser beam with the first local oscillation laser, or mix the reflected laser beam and the second local oscillation laser; a balance detector configured to receive output of the first mixer and detect a beat frequency of the ascending-frequency duration and a beat frequency of the descending-frequency duration.

### BRIEF DESCRIPTION OF THE DRAWINGS

In order to describe technical solutions in the embodiments of the present disclosure more clearly, drawings needed to be used in description of the embodiments of the present disclosure will be briefly introduced below. Obviously, the drawings in the following description are only some embodiments of the present disclosure. Those of ordinary skill in the art can obtain other drawings based on these drawings without exerting creative efforts.

FIG. 1 is a waveform diagram of an emitted beam and a received beam using a relevant FWCW frequency sweep method in the related art;

FIG. 2A is a schematic diagram of angle mismatch caused to the emitted beam by a rotating mirror of a related light detection and ranging system;

FIG. 2B is a schematic diagram of compensating for the angle mismatch of the emitted beam by a light detection and ranging system of the present disclosure;

FIG. 3A to FIG. 3F are schematic structural diagrams of the light detection and ranging system provided by the present disclosure;

FIG. 4A and FIG. 4B are waveform diagrams of detection signals of the light detection and ranging system provided by the present disclosure; and

FIG. 5A and FIG. 5B show schematic diagrams of an autonomous vehicle including the light detection and ranging system of the present disclosure.

### DETAILED DESCRIPTION

The term “and/or” used herein is just an association relationship describing related targets, indicating that there can be three relationships, for example, A and/or B can mean three cases which are A alone exists, A and B exist simultaneously, B exists alone. In addition, a character “/” herein generally indicates that the related targets after and before the character “/” have an “or” relationship.

It should be understood that although the terms first, second, third, etc. may be used to describe different targets in the embodiments of the present application, these targets should not be limited to these terms. These terms are used only to differentiate the targets. For example, without departing from the scope of the embodiments of the present application, the first may also be called the second, and similarly, the second may also be called the first.

It should also be noted that the terms “comprise”, “include” or any other variation thereof are intended to cover a non-exclusive inclusion, such that an article or an apparatus including a list of elements includes not only those elements but also those not expressly listed other elements, or elements inherent to such article or apparatus. Without further limitation, an element defined by a statement “comprise a/an” does not exclude presence of other identical elements in the article or the apparatus including the stated element.

The related Frequency-Modulated Continuous Wave (FMCW) light detection and ranging system mainly transmits and receives continuous laser beams, enables the reflected light to interfere with local oscillator light, and uses frequency-mixing detection technology to measure frequency difference between the transmitted beam and the received beam. The distance of the target is then calculated through converting the frequency difference.

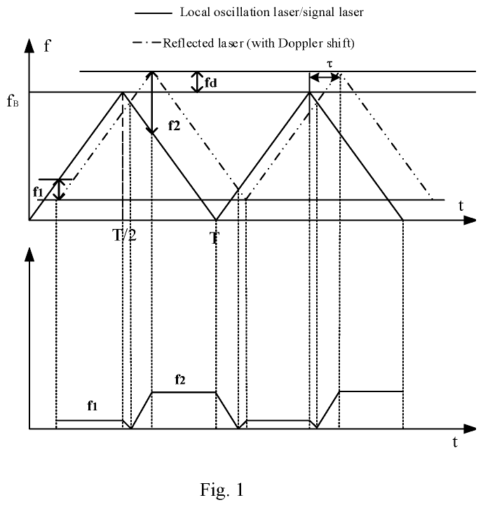

FIG. 1 shows a schematic diagram of measurement of moving targets using a relevant triangular wave Linear Frequency Modulated Continuous Wave (FMCW) light detection and ranging system. In FIG. 1, solid line triangle waves are instantaneous time-frequency relationship of a signal beam (i.e., the emitted beam) or a local oscillation beam of the light detection and ranging system, and dotted line triangle waves are instantaneous time-frequency relationship of a reflected beam of a target moving toward the light detection and ranging system, where t is a time delay of the reflected beam of the target; f₁ and f₂ are beat frequencies of the reflected beam of the target in an ascending-frequency sweep part and a descending-frequency sweep part, respectively, i.e., beat frequencies in an ascending-frequency duration and in a descending-frequency duration between the reflected beam and the local oscillation beam. T is a period including one ascending-frequency sweep part and one descending-frequency sweep part, f is a frequency sweep bandwidth of linear frequency modulation, f_{d}=(f₂−f₁)/2. In FIG. 1, beat frequencies of the ascending-frequency duration and the descending-frequency duration of the reflected beam are:

$$\begin{matrix}{f}_{1} = \frac{2 {f}_{B}}{T} \cdot \frac{2 R}{c} - \frac{2 v}{λ} \\ {f}_{2} = \frac{2 {f}_{B}}{T} \cdot \frac{2 R}{c} + \frac{2 v}{λ}\end{matrix} \qquad Formula 1$$

the distance and the velocity of the target are as follows:

$$\{ \begin{matrix}R = \frac{( {f}_{1} + {f}_{2} ) \cdot T \cdot c}{8 {f}_{B}} \\ v = \frac{( {f}_{2} - {f}_{1} ) \cdot λ}{4}\end{matrix} \qquad Formula 2$$

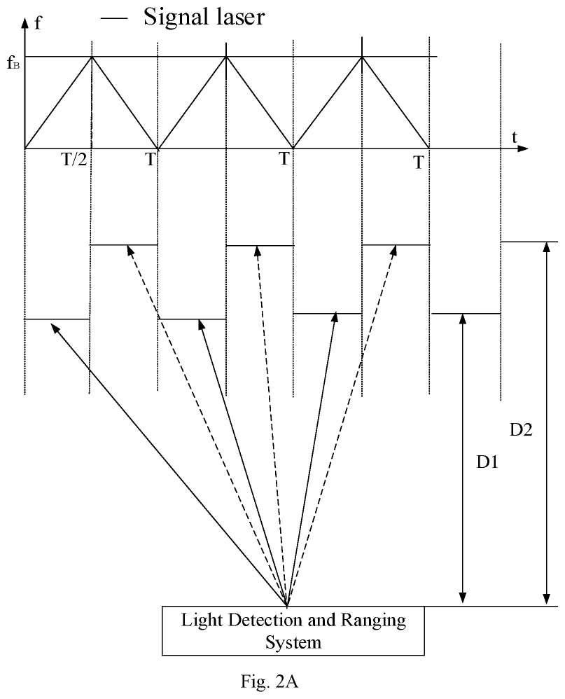

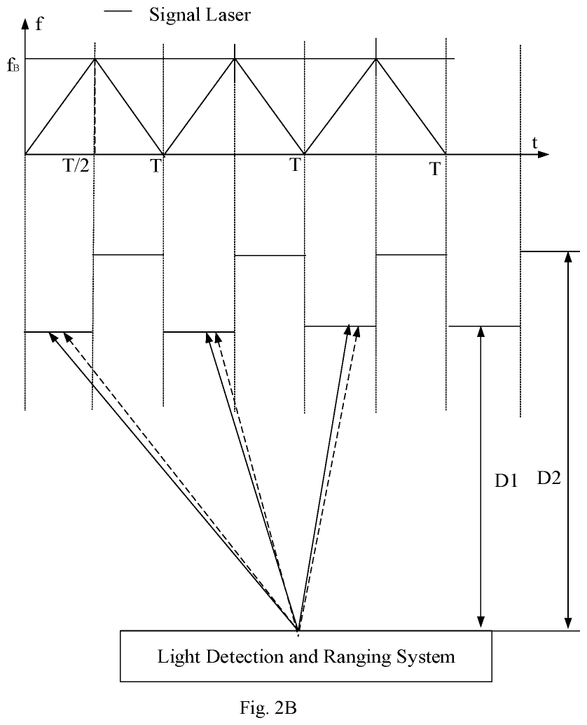

FMCW light detection and ranging system has significant technical advantages, but there are the following problems in its practical application: related light detection and ranging system includes a rotating mirror. A transmitting portion of the light detection and ranging system emits laser to the rotating mirror, the rotating mirror reflects the laser to the target being measured, the target to be measured reflects the laser to the rotating mirror, and the rotating mirror reflects the laser to the receiving portion. During this process, continuous rotation of the rotating mirror may cause adjacent ascending-frequency signals and descending-frequency signals to illuminate different targets or different parts of the same target, as shown by solid and dotted lines in FIG. 2A. Since distances (D1 and D2 in FIG. 2A) between different detected targets or different parts of the same target and the light detection and ranging system are different, there will be an error in the calculated distance and the calculated speed of the target using the above formulas 1 and 2 of the local oscillation beam and the reflected beam. This error is also called an angle mismatch of the rotating mirror. This angle mismatch affects the measurement accuracy of the light detection and ranging system.

In order to solve this technical problem, a method is to simultaneously emit a signal beam in the ascending-frequency stage and a signal beam in the descending-frequency stage. However, the disadvantage of this method is that two detection systems are needed, which increases the cost of the system and increases the size of the system.

In response to the above technical problems, the present application provides a light detection and ranging system that generates a constant angle compensation for the adjacent signal beams in the ascending-frequency stage and in the descending-frequency stage, thereby solving the above angle mismatch problem, as shown in FIG. 2B. In addition, the light detection and ranging system of the present application only uses one detection system, which does not increase the cost and size of the system.

Specific embodiments of the present disclosure will be described in detail below with reference to the accompanying drawings.

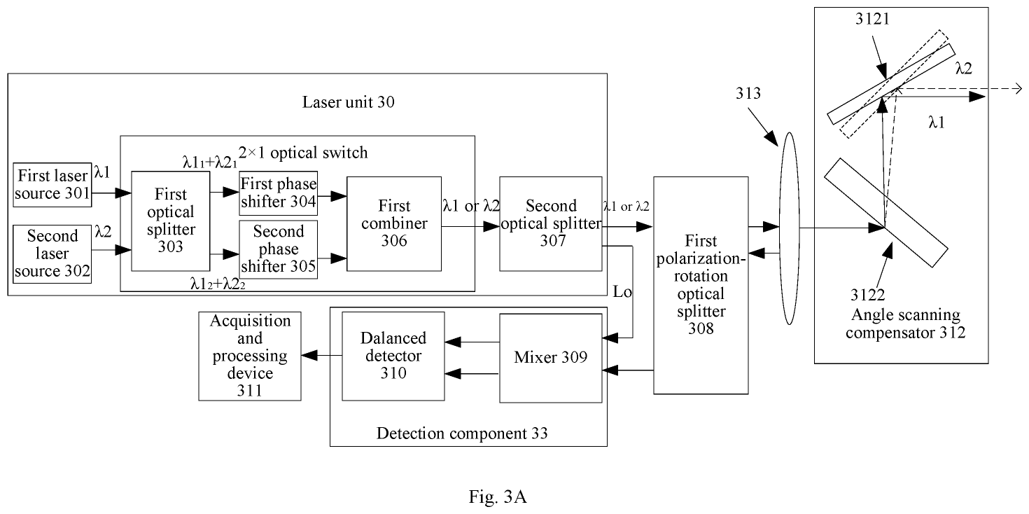

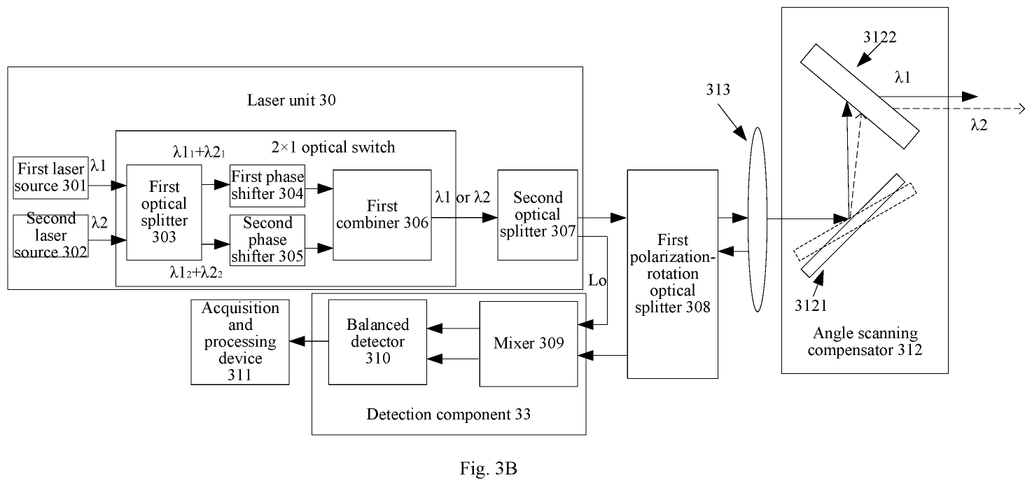

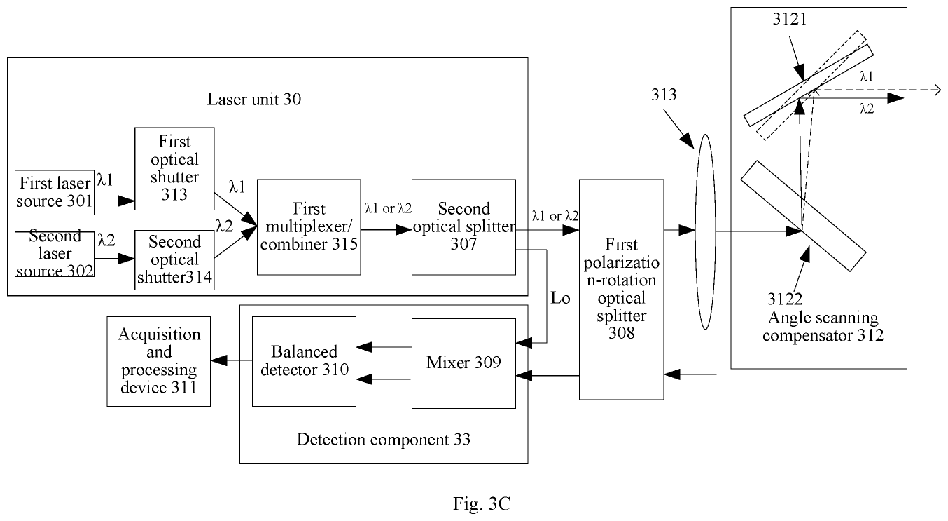

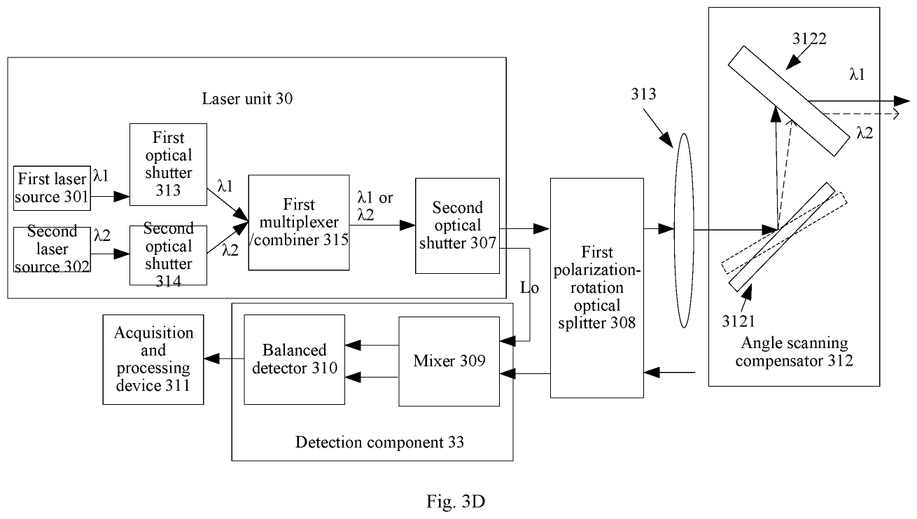

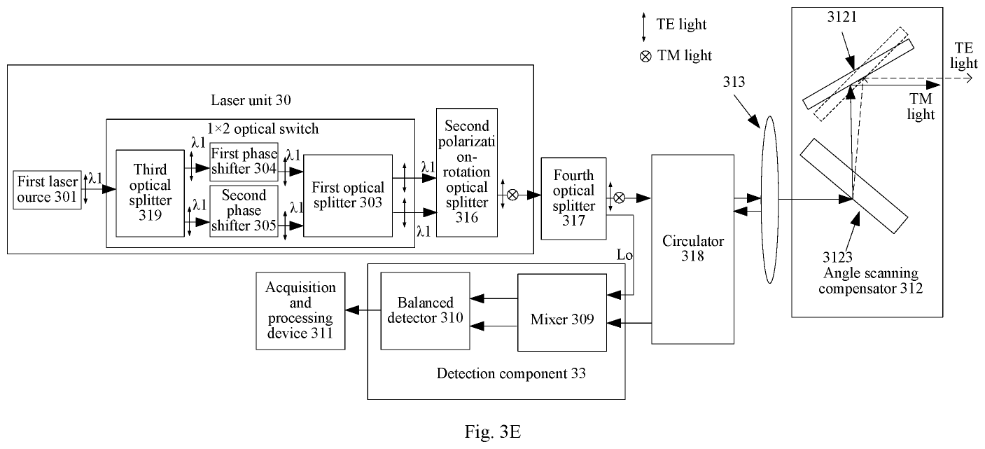

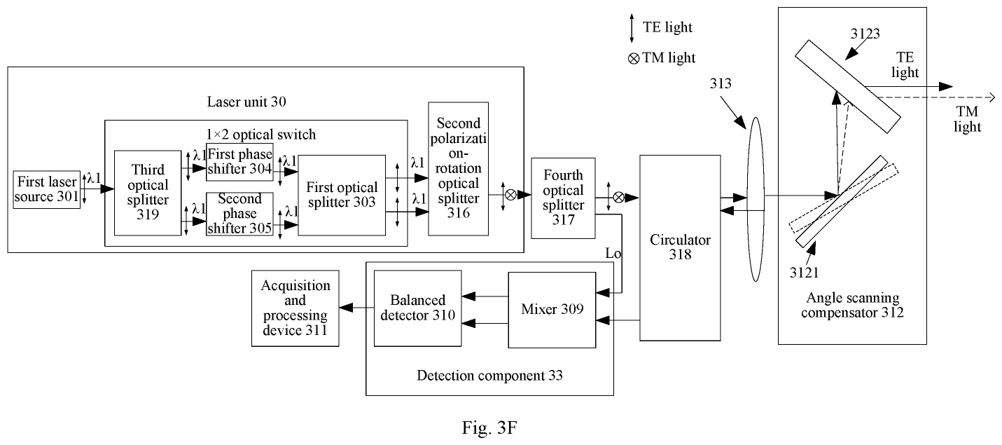

FIG. 3A is a schematic structural diagram of a light detection and ranging system provided by some embodiments of the present application. As shown in FIG. 3A, the light detection and ranging system includes at least one laser transmission and detection channel. Although only one laser transmission and detection channel is shown in FIG. 3A, those skilled in the art can understand that the light detection and ranging system can include more than two laser transmission and detection channels arranged together or in parallel), and each laser transmission and detection channel can independently or cooperatively perform measurement, and the detection lasers emitted by the laser transmission and detection channels correspond to different positions of the target.

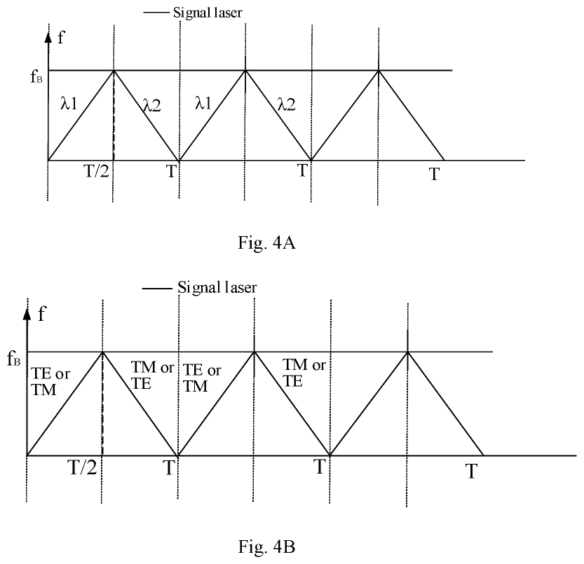

Any laser transmission and detection channel in the light detection and ranging system may include a laser unit 30. The laser unit 30 is configured to emit a first signal laser and a second signal laser in a time-division manner. The first signal laser and the second signal laser are FMCW frequency modulated lasers. The first signal laser has an ascending-frequency duration, and the second signal laser has a descending-frequency duration. The wavelength of the first signal laser is λ1, and the wavelength of the second signal laser is λ2. The wavelength of the first signal laser is different from the wavelength of the second signal laser (i.e. λ1≠λ2). An ascending-frequency duration of the first signal laser and a descending-frequency duration of the adjacent second signal laser can form a frequency-sweep period of a triangular waveform. The sweep period is T, as shown in FIG. 4A. FIG. 4A shows that the first signal laser is in the ascending-frequency duration, and the second signal laser is in the descending-frequency duration.

Specifically, the laser unit 30 may include a first laser source 301 and a second laser source 302. The first laser source 301 may emit a modulated first laser beam. A wavelength of the first laser beam is λ1. The second laser source 302 may emit a modulated second laser beam. A wavelength of the second laser beam can be λ2. Each of the first laser beam and the second laser beam may have a triangular waveform, and the triangular waveform may be as shown in FIG. 4A. Either one of the first laser source 301 and the second laser source 302 is, for example, a solid-state laser device, a semiconductor laser device, etc., specifically a distributed feedback laser (DFB) device, a vertical cavity surface emitting laser (VCSEL) device, an external cavity laser device, etc. Each of the first laser source 301 and the second laser source 302 may include a modulator that receives a modulation signal, and the modulator may be configured to modulate a laser beam based on the modulation signal, such that each of the first laser source 301 and the second laser source 302 generates and outputs a frequency-sweep laser beam, that is, a beam whose frequency changes within a predetermined range. The frequencies of the laser beams outputted by the first laser source 301 and the second laser source 302 when unmodulated are substantially constant, which are called the frequencies of unmodulated beams. The first laser source 301 and the second laser source 302 can output the frequency-sweep beams after the first laser source 301 and the second laser source 302 perform the modulation. The first laser source 301 and the second laser source 302 may also be, for example, external light sources, which are introduced into the laser transmission and detection channel through an optical path (such as an optical fiber). The first laser beam may have an ascending-frequency duration and the second laser beam may have a descending-frequency duration. The wavelength of the first laser beam is λ1 and the wavelength of the second laser beam is λ2. The wavelength of the first laser beam is different from the wavelength of the second laser (i.e. λ1≠λ2). An ascending-frequency duration of the first laser beam and a descending-frequency duration of the second laser beam can form a frequency-sweep period of a triangular waveform.

Optionally, the laser unit 30 may also include a 2×1 optical switch. The 2×1 optical switch can be an integrated optical switch or an on-chip optical switch. The 2×1 optical switch is configured to selectively output the first laser beam or the second laser beam in a time-division manner. In some cases, the 2×1 optical switch can output the first laser beam in a first half of a frequency-sweep period T, the first laser beam has a gradually ascending frequency, the 2×1 optical switch can output the second laser beam in a second half of the frequency-sweep period T, the second laser beam has a gradually descending frequency; or the 2×1 optical switch can output the second laser beam in the first half of a frequency-sweep period T, the first laser beam has the gradually ascending frequency, the 2×1 optical switch can output the second laser beam in the second half of the frequency-sweep period T, the second laser beam has the gradually descending frequency.

Specifically, the 2×1 optical switch may include a first optical splitter 303, a first phase shifter 304, a second phase shifter 305, and a first combiner 306. The first optical splitter 303 is configured to receive the first laser beam and the second laser beam, divide the first laser beam into a first component of the first laser beam and a second component of the first laser beam, and divide the second laser beam into a first component of the second laser beam and a second component of the second laser. The first optical splitter 303 includes two input ports and two output ports. The first optical splitter 303 receives the first laser beam and the second laser beam from the two input ports respectively, outputs the first component of the first laser beam and the first component of the second laser beam at a first output port of the two output ports, and outputs the second component of the first laser beam and the second component of the second laser beam at a second output port of the two output ports. The first component of the first laser beam and the second component of the first laser beam may have the same waveform and wavelength as the first laser beam, and the first component of the second laser beam and the second component of the second laser beam may have the same waveform and wavelength as the second laser beam.

The first phase shifter 304 is configured to receive the first component of the first laser beam and the first component of the second laser beam, and performs phase-shift to the first component of the first laser beam and the first component of the second laser beam; the second phase shifter 305 is configured to receive the second component of the first laser beam and the second component of the second laser beam, and performs phase-shift to the second component of the first laser beam and the second component of the second laser beam. The first phase shifter 304 and the second phase shifter 305 may changes phases of the first component of the first laser beam, the second component of the first laser beam, the first component of the second laser beam and the second component of the second laser beam, so that in a first case, phase difference between the first component of the first laser beam and the second component of the first laser beam is 0 degree, and phase difference between the first component of the second laser beam and the second component of the second laser beam is 180 degrees; or in the second case, the phase difference between the first component of the first laser beam and the second component of the first laser beam is 180 degrees, and the phase difference between the first component of the second laser beam and the second component of the second laser beam is 0 degree.

In some embodiments, the first phase shifter 304 and the second phase shifter 305 may jointly adjust phases of the first component of the first laser beam, the second component of the first laser beam, the first component of the second laser beam, and the second component of the second laser beam under the control of a controller within the laser unit 30 or outside the laser unit 30.

In some embodiments, the first combiner 306 has two input ends and one output end, and is configured to receive a phase-shifted first component of the first laser beam and a phase-shifted first component of the second laser beam and/or receive a phase-shifted second component of the first laser beam and a phase-shifted second component of the second laser beam. When the phases of the first component of the first laser beam and the second component of the first laser beam differ by 0 degrees and the first component of the second laser beam and the second component of the second laser beam differ by 180 degrees, the output end of the first combiner 306 outputs the first laser beam; when the first component of the first laser beam and the second component of the first laser beam differ by 180 degrees and the first component of the second laser beam and the second component of the second laser beam differ by 0 degree, the output end of the first combiner 306 outputs the second laser beam.

In this embodiment, the first phase shifter 304 and the second phase shifter 305 can perform phase-shift of the first components of the first laser beam and the second laser beam, so that the first component and the second component of the first laser beam entering the first combiner 306 differ by 180 degrees, and have phases inverse to each other and being counteracted. In another embodiment, the first phase shifter 304 and the second phase shifter 305 can perform phase-shift of the first component of the second laser beam and the second component of the second laser beam, so that the first component of the second laser beam and the second component of the second laser beam entering the first combiner 306 differ by 180 degrees, and have phases inverse to each other and being counteracted. Therefore, by controlling the first phase shifter 304 and the second phase shifter 305 to perform the phase-shift of the first component of the first laser beam, the second component of the first laser beam, the first component of the second laser beam, and the second component of the second laser beam, the first combiner 306 can selectively output the first laser beam or the second laser beam. Therefore, the 2×1 optical switch realizes output switching between the first laser beam and the second laser beam.

Optionally, the laser unit 30 also includes a second optical splitter 307. The second optical splitter 307 is arranged at an optical output end of the 2×1 optical switch and is configured to receive the first laser beam or the second laser beam outputted in a time-division manner from the 2×1 optical switch, and divide the first laser beam into a first local oscillation laser and a first signal laser, or divide the second laser into a second local oscillation laser and a second signal laser. The first local oscillation laser, the first signal laser and the first laser beam have the same wavelength, the same frequency-sweep period and the same phase. The second local oscillation laser, the second signal laser and the second laser beam have the same wavelength, the same frequency-sweep period and the same phase.

Optionally, each laser transmission and detection channel may also include a first polarization-rotation optical splitter 308. The first polarization-rotation optical splitter 308 may be a single Polarization Splitting Rotator (PSR) or may be Polarization Splitter (PS) and Polarization Rotator (PR) connected together. The first polarization-rotation optical splitter 308 is configured to receive the first signal laser and the second signal laser in a time-division manner, and to receive a reflected laser beam. Specifically, the first polarization-rotation optical splitter 308 may be configured to receive the first signal laser or the second signal laser from a first port, emit the first signal laser or the second signal laser at the second port, and receive the reflected laser beam and transmit the reflected laser beam from the second port to a third port. The reflected laser beam may be the reflected laser beam generated after a detection laser beam of the light detection and ranging system is irradiated onto the target.

Optionally, each laser transmission and detection channel may also include an angle scanning compensator 312. The angle scanning compensator 312 is configured to receive the first signal laser and the second signal laser in a time-division manner, and to emit the first signal laser and the second signal laser in substantially identical direction in a time-division manner. Specifically, the angle scanning compensator 312 includes a dispersion device 3122 and a rotating mirror 3121. As shown in FIG. 3A, the dispersion device 3122 is configured to receive the first signal laser and the second signal laser in a time-division manner. Since the wavelengths of the first signal laser and the second signal laser are different, when the first signal laser and the second signal laser are incident on the dispersion device 3122 at the same incident angle, the first signal laser and the second signal laser are emitted from the dispersion device 3122 at different angles. Due to the rotation of the rotating mirror 3121, if the first signal laser and the second signal laser are incident on the rotating mirror 3121 at the same incident angle, the rotating mirror will emit the first signal laser and the second signal laser at different angles, causing the first signal laser and the second signal laser to be incident onto different targets or different parts of the same target. Thus, using the reflected light to calculate the speed and the distance of the target will cause an angle mismatch problem. By providing the dispersion device 3122, angle deviation caused by the rotation of the rotating mirror can be compensated, so that emission directions of the first laser signal and the second laser signal outputted by the angle scanning compensator 312 are basically the same, thus solving the problem of angle mismatch.

The dispersion device 3122 may be configured so that emission angles of the first signal laser and the second signal laser may be different. Specifically, one or more of the material, thickness, and refractive index of the dispersion device 3122 may be configured or selected such that the first signal laser and the second signal laser leave the dispersion device 3122 at different angles. For example, the dispersion device 3122 can be a grating, a prism or a wedge-shaped block, and the angle and the material of the grating, the prism or the wedge-shaped block can be selected, so that the dispersion device 3122 can enable the first signal laser with a wavelength λ1 to rotate by a first angle α, an enable the second signal laser with a wavelength λ2 to rotate by a second angle β, where the angle difference |α−β| may be a preset value. This preset value can be selected based on a rotational speed of the rotating mirror 3121 and the scanning period T of the light detection and ranging system, so that the emission directions of the first signal laser and the second signal laser emitted by the angle scanning compensator 312 are basically the same, as shown in FIG. 2B. In some embodiments, the emission direction of the first signal laser emitted by the angle scanning compensator 312 and the emission direction of the second signal laser by the angle scanning compensator 312 may have an included angle of 0 to 5 degrees, such as an included angle of 0 degree, 1 degree, or 2 degrees, 3 degrees, 4 degrees or 5 degrees. In other embodiments, the emission direction of the first signal laser emitted by the angle scanning compensator 312 and the emission direction of the second signal laser emitted by the angle scanning compensator 312 may have an included angle of 0-10 degrees, such as an included angle of 0-6 degrees, 0-7 degrees, 0-8 degrees, 2-5 degrees, 3-6 degrees, 1-7 degrees. The present application is not limited to this.

The first signal laser and the second signal laser are irradiated onto the target to generate reflected laser beam. Since the emission directions of the first signal laser and the second signal laser are basically the same, the reflection directions of the reflected laser beams are also basically the same. The reflected laser beam may include the reflected laser beam of the first signal laser and/or the reflected laser beam of the second signal laser. The reflected laser beam of the first signal laser and the reflected laser beam of the second signal laser are received by a light receiver of the light detection and ranging system at different time instants. The light receiver of the light detection and ranging system may transmit the reflected laser beam to the second port of the first polarization-rotation optical splitter 308, and the first polarization-rotation optical splitter 308 may transmit the reflected laser beam to the third port.

Optionally, each laser transmission and detection channel also includes a detection component 33. The detection component 33 is configured to receive the reflected laser beam from the third port of the first polarization-rotation optical splitter 308. The reflected laser beam may be a reflected laser beam with the period T. Referring to FIG. 1 and FIG. 3A, the ascending-frequency duration of the reflected laser beam may be first reflected laser beam with a wavelength that is the same as or close to λ1, and the descending-frequency duration may be second reflected laser beam with a wavelength that is the same as or close to λ2. Specifically, the detection component 33 can receive the first reflected laser beam with a wavelength that is the same as or close to λ1 and the second reflected laser beam with a wavelength that is the same or close to λ2 in a time-division manner, as well as the first local oscillation laser and the second local oscillation laser in a time-division manner.

Specifically, the detection component may include a mixer 309 configured to receive the first local oscillation laser and the first reflected laser beam or receive the second local oscillation laser and the second reflected laser, and make the first local oscillation laser interfere with the second reflected laser beam to interfere with each other, and make the second local oscillation laser interfere with the second reflected laser beam, to generate coherent signals. Optionally, the mixing device may be a coupler, such as a 2×2 coupler.

Optionally, the detection component 33 may also include a balanced detector 310. The balanced detector 310 may be configured to receive an output signal of the mixer 309 and detect a beat frequency between the first local oscillation laser and the first reflected laser beam a and a beat frequency between the second local oscillation laser and the second reflected laser beam according to the output signal, and output a detection result. The balanced detector 310 may include one or more photodetectors.

Optionally, the light detection and ranging system of the present application may also include an acquisition and processing device 311. The acquisition and processing device 311 is configured to receive an output of the balanced detector 310, and determine beat frequency signals based on the output, and obtain the distance and/or the speed of the target through calculation.

The coupler, the mixer 309, the balanced detector 310, the photodetector, and the acquisition and processing device 311 are common devices in the field of the FMCW light detection and ranging system, and will not be described in detail here. The acquisition and processing device 311 includes, for example, an acquisition device and a processor. The acquisition device can convert an analog signal into a digital signal related to detection information, such as an analog-to-digital converter. The processor processes the digital signal to determine the distance and the speed of the target relative to the light detection and ranging system. The processor may be a field programmable gate array (FPGA), a digital signal processer (DSP), etc.

In some embodiments, as shown in FIG. 3A, the light detection and ranging system further includes a lens component 313. The lens component 313 is disposed between the first polarization-rotation optical splitter 308 and the angle scanning compensator 312, and is configured to perform collimation on the laser outputted by the first polarization-rotation optical splitter 308, and perform focus of the reflected laser beam so that the reflected laser beam may be irradiated into the first polarization-rotation optical splitter 308.

In some embodiments, the light detection and ranging system further includes a beam scanning and guide device, which is disposed between the lens component 313 and the target to achieve deflection and scanning of the laser. The beam scanning and guide device may be disposed between the angle scanning compensator 312 and the target, or may be disposed between the lens assembly 312 and the angle scanning compensator 312.

The light detection and ranging system provided by the present disclosure can perform angle compensation on the laser emitted by the rotating mirror, thereby avoiding the angle mismatch caused by two consecutive ascending-frequency phase signal and descending-frequency phase signal during the rotation of the rotating mirror, and can improve the measurement accuracy of the light detection and ranging system. In addition, the solution of the present application only requires one detection component, thereby saving the number of components and reducing the space occupied by the components.

FIG. 3B is another structural schematic diagram of the light detection and ranging system of the present application. The structure of the light detection and ranging system shown in FIG. 3B is similar to the structure of the light detection and ranging system shown in FIG. 3A. The difference between the two structures in FIG. 3A and FIG. 3B is that the structure of the angle scanning compensator 312 in the light detection and ranging system in the embodiment of FIG. 3B is different from the structure of the angle scanning compensator 312 in the light detection and ranging system in FIG. 3A. Specifically, the angle scanning compensator 312 includes the dispersion device 3122 and the rotating mirror 3121. As shown in FIG. 3B, the rotating mirror 3121 is configured to receive the first signal laser and the second signal laser from the first polarization-rotation optical splitter 308 in a time-division manner, and project the first signal laser and the second signal laser onto the dispersion device 3122, and the dispersion device 3122 is configured to receive the first signal laser and the second signal laser in a time-division manner. Due to the rotation of the rotating mirror 3121, there is angular difference between the first signal laser and the second signal laser projected onto the dispersion device 3122 by the rotating mirror 3121. Since the wavelengths of the first signal laser and the second signal laser are different, when the first signal laser and the second signal laser are incident on the dispersion device 3122 at the above incident angle difference, it is possible to enable the emission angles of the first signal laser and the second signal laser to be the same by configuring the dispersion device 3122, thereby overcoming the above angle mismatch problem. The operational principles of other devices shown in FIG. 3B are similar to the operational principles of the corresponding devices shown in FIG. 3A. For details of the devices, please refer to the relevant description in FIG. 3A above which will not be described in detail here to avoid repetition.

FIG. 3C is a third schematic structural diagram of the light detection and ranging system of the present application. As shown in FIG. 3C, any laser transmission and detection channel of the light detection and ranging system may include the laser unit 30. The laser unit 30 is configured to emit a first laser and a second signal laser in a time-division manner. Each of the first signal laser and the second signal laser is an FMCW laser. The first signal laser has an ascending-frequency duration, and the second signal laser has a descending-frequency duration. The wavelength of the first signal laser is λ1, and the wavelength of the second signal laser is λ2. The wavelength of the first signal laser is different from the wavelength of the second signal laser. An ascending-frequency duration of the first signal laser and a descending-frequency duration of the adjacent second signal laser can form a frequency-sweep period of a triangular waveform. The frequency-sweep period is T.

Specifically, the laser unit 30 may include the first laser source 301 and the second laser source 302. The first laser source 301 may emit a modulated first laser beam. The wavelength of the first laser beam is λ1. The second laser source 302 may emit a modulated second laser beam. The wavelength of the second laser beam is λ2. The first laser beam and the second laser beam may have the same waveform. The first laser source 302 may have the same function and structure as that of the first laser source in FIG. 3A, and the second laser source 302 may have the same function and structure as that of the second laser source 302 shown in FIG. 3A and FIG. 3B. For related content of the first laser source 301 and the second laser 302, please refer to the above relevant description of FIG. 3A and Fig. B, which will not be described in detail here.

Optionally, the laser unit 30 may also include a first optical shutter 313, a second optical shutter 314, a first multiplexer/combiner 315. The first optical shutter 313 is arranged at a light output end of the first light source 301 and is configured to allow the first laser beam to pass or not (i.e., cut off). The second optical shutter 314 is arranged at a light output end of the second light source 302 and is configured to allow the second laser beam to pass or not (i.e., cut off). The first optical shutter 313 and the second optical shutter 314 can control passage or non-passage of the lasers under the control of an external controller. The external controller may be a controller known to those skilled in the art, and is not described in detail here in order to avoid repetition. The first multiplexer/combiner 315 is provided at an output end of the first optical shutter 313 and the second optical shutter 314, and is configured to receive the first laser beam from the first optical shutter 313 or the second laser beam from the second optical shutter 314 in a time-division manner, and output the first laser beam or the second laser beam in a time-division manner. For example, the first multiplexer/combiner 315 can output the first laser with a gradually increasing frequency in the first half of a frequency-sweep period T and the second laser with a gradually decreasing frequency in the second half of the frequency-sweep period T, or output the second laser with a gradually increasing frequency in the first half of a frequency-sweep period T and the first laser with a gradually decreasing frequency in the second half of the frequency-sweep period T. The first multiplexer/combiner 315 outputs the first laser or the second laser to the second optical splitter 307. The operational principles of other devices shown in FIG. 3C are similar to the operational principles of the corresponding devices shown in FIG. 3A. For details of the devices, please refer to the relevant description in FIG. 3A above which will not be described in detail here to avoid repetition.

FIG. 3D is a fourth schematic structural diagram of the structure of the light detection and ranging system of the present application. The structure of the light detection and ranging system shown in FIG. 3D is similar to the structure of the light detection and ranging system shown in FIG. 3C. The difference between the structures in FIGS. 3C and 3D is that the structure of the angle scanning compensator 312 in the light detection and ranging system in the embodiment of FIG. 3D is different from the structure of the angle scanning compensator 312 in the light detection and ranging system in FIG. 3C. Specifically, the angle scanning compensator 312 in FIG. 3D includes the dispersion device 3122 and the rotating mirror 3121. As shown in FIG. 3D, the rotating mirror 3121 is configured to receive the first signal laser and the first signal laser from the first polarization-rotation optical splitter 308 in a time-division manner, and then project the first signal laser and the second signal laser onto the dispersion device 3122. The dispersion device 3122 is configured to receive the first signal laser and the second signal laser in a time-division manner. Due to the rotation of the rotating mirror, there is angular difference between the first signal laser and the second signal laser projected onto the dispersion device 3122 by the rotating mirror 3121. Since the wavelengths of the first signal laser and the second signal laser are different, when the first signal laser and the second signal laser are incident on the dispersion device 3122 at the above angle difference, the dispersion device 3122 can make the first signal laser and the second signal laser to be emitted at the same or substantially same angle, thereby overcoming the above angle mismatch problem. The operational principles of other devices shown in FIG. 3D are similar to the operational principles of the corresponding devices shown in FIG. 3B and FIG. 3C. For details of the devices, please refer to the relevant descriptions in FIG. 3B and FIG. 3C above, which will not be described in detail here in the present application.

FIG. 3E is a fifth schematic structural diagram of the light detection and ranging system provided by some embodiments of the present application. As shown in FIG. 3E, the light detection and ranging system includes at least one laser transmission and detection channel. Although only one laser transmission and detection channel is shown in FIG. 3E, those skilled in the art can understand that the light detection and ranging system can include more than two laser transmission and detection channels arranged in parallel, and each laser transmission and detection channel can independently or collaboratively perform measurement, and the detection lasers emitted by the laser transmission and detection channel correspond to different positions of the target.

Any laser transmission and detection channel may include a laser unit 30. The laser unit 30 is configured to emit a first laser and a second laser in a time-division manner. The first laser and the second laser are FMCW lasers. The first laser has an ascending-frequency duration, and the second laser has a descending-frequency duration. The first laser can be transverse electric (TE) mode light, and the second laser can be transverse magnetic (TM) mode light; or, the second laser can be TE mode light and the first laser may be the TM mode light. An ascending-frequency duration of the first laser and a descending-frequency duration of the adjacent second laser can form a frequency-sweep period of a triangular waveform. The frequency-sweep period is T.

Specifically, the laser unit 30 may include a first laser source 301, and the first laser source 301 may emit a modulated first laser beam. The structure and operational principle of the first laser source 301 are the same as the first laser source 301 shown in FIG. 3A to FIG. 3D. For details of the first laser source, please refer to the above description of the first laser source 301. In some embodiments, the first laser beam outputted by the first laser source 301 may be TE mode light or TM mode light. The first laser source 301 is, for example, a solid-state laser device, a semiconductor laser device, etc. Specifically, the first laser source 301 can be a distributed feedback laser (DFB) device, a vertical cavity surface emitting laser (VCSEL) device, an external cavity laser device, etc. The first laser source 301 may include a modulator that receives a modulation signal, and the modulator may be configured to modulate a light beam based on the modulation signal, so that the first laser source 301 generates and outputs a frequency-sweep beam, that is, a light beam whose frequency changes within a predetermined range. The frequency of the laser beam output by the first laser source 301 when not modulated is substantially constant, which is called the frequency of the unmodulated beam. The first laser source 301 can output a frequency-sweep beam after modulation. The first laser source 301 may also be, for example, an external light source, which is introduced into the laser transmission and detection channel through an optical path (such as an optical fiber).

Optionally, the laser unit 30 may also include a 1×2 optical switch. The 1×2 optical switch can be an integrated optical switch or an on-chip optical switch. The 1×2 optical switch is configured to selectively output a first combined laser or a second combined laser in a time-division manner. In some cases, the 1×2 optical switch can output the first combined laser with a gradually ascending frequency in the first half of a frequency-sweep period T, and output the second combined laser with a gradually descending frequency in the second half of the frequency-sweep period T; or, the 1×2 optical switch can output the second combined laser with a gradually ascending frequency in the first half of a frequency-sweep period T and the first combined laser with a gradually descending frequency in the second half of the frequency-sweep period T.

Specifically, the 1×2 optical switch may include a third optical splitter 319, the first phase shifter 304, the second phase shifter 305, and the first optical splitter 303. The third optical splitter 319 is configured to receive the first laser beam and split the first laser beam into a first laser component and a second laser component. The first laser component and the second laser component have the same period, the same waveform, and the same wavelength as the first laser beam. The first laser component and the second laser component also have the same polarization direction, for example, both are TE light or both are TM light.

The first phase shifter 304 is configured to receive the first laser component, perform phase-shift of the first laser component, and output the phase-shifted first laser component. The second phase shifter 305 is configured to receive the second laser component, perform phase-shift of the second laser component, and output the phase-shifted second laser component. Specifically, a phase of the first laser component may be shifted by a first phase, and a phase of the second laser component may be shifted by a second phase. The first phase and the second phase differ by 90 degrees or −90 degrees. Optionally, under the control of a controller provided inside or outside the laser unit 30, the first phase shifter 304 can perform phase-shift the first laser component, and the second phase shifter 305 can perform phase-shift of the second laser component, so that the first laser component and the second laser component may differ by 90 degrees or −90 degrees.

The first optical splitter 303 is configured to receive the phase-shifted first laser component and the phase-shifted second laser component, and output the first combined laser or the second combined laser. In some embodiments, the first laser beam, the first laser component, and the second laser component have the same wavelength and the same phase. The first laser beam, the phase-shifted first laser component, the phase-shifted second laser component, the first combined laser and the second combined laser may have the same wavelength and/or waveform.

Specifically, the first optical splitter 303 has two input ports and two output ports, and the first optical splitter 303 receives the phase-shifted first laser component and the phase-shifted second laser component from the two input ports respectively, and output the first combined laser from a first output port of the two output ports and output the second combined laser from a second output port of the two output ports. When the phase of the phase-shifted first laser component and the phase of the phase-shifted second laser component differ by 90 degrees, the first optical splitter 303 outputs the first combined laser; when the phase-shifted first laser component and the phase-shifted second laser component differ by −90 degrees, the first optical splitter 303 outputs the second combined laser. Therefore, by controlling the first phase shifter 304 and the second phase shifter 305 to shift the phases of the first laser component and the second laser component, the first optical splitter 306 can selectively output the first combined laser or the second combined laser.

Optionally, the laser unit 30 also includes a second polarization-rotation optical splitter 316. The second polarization-rotation optical splitter 316 is arranged at a light emitting end of the 1×2 optical switch and is configured to receive the first combined laser or the second combined laser outputted from the 1×2 optical switch in a time-division manner. The second polarization-rotation optical splitter 316 allows the polarization state of the first combined laser to remain unchanged and changes the polarization state of the second combined laser. For example, the first combined laser and the second combined laser are both TE light (or both TM light), and the second polarization-rotation optical splitter 316 can receive the first combined laser and the second combined laser, maintain the polarization state of the first combined laser unchanged, that is, the first combined laser is still TE light (or still TM light) after passing through the second polarization-rotation optical splitter 316; and the second polarization-rotation optical splitter 316 can change the polarization state of the second combined laser, that is, the second combined laser becomes TM light (or becomes TE light) after passing through the second polarization-rotation optical splitter 316. The second polarization-rotation optical splitter 316 outputs the first combined laser and the second polarized combined laser in a time-division manner. The first combined laser is TE light (or TM light), and the second polarized combined laser is TM light (or TE light).

Optionally, each laser transmission and detection channel may also include a fourth optical splitter 317, which is configured to receive the first combined laser or the second polarized combined laser outputted from the second polarization-rotation optical splitter 316 in a time-division manner, and split each of the received combined laser beams into a signal laser and a local oscillation laser. In this embodiment, since the first combined laser and the second polarized combined laser are received in a time division manner, when the fourth optical splitter 317 receives the first combined laser, the signal combined laser and the local oscillation laser are a first signal laser and a first local oscillation laser, respectively, and the waveform, the phase and the polarization state of the first signal laser and the first local oscillation laser are the same as those of the first combined laser. When the fourth optical splitter 317 receives the second polarized combined laser, the signal combined laser and the local oscillation laser are a second signal laser and a second local oscillation laser, respectively, and the waveform, the phase and the polarization state of the first signal laser and the first local oscillation laser are the same as those of the second polarized combined laser. Therefore, the signal combined laser and the local oscillation combined laser have different polarization states according to different time periods.

Optionally, each laser transmission and detection channel may also include a circulator 318. The circulator 318 is arranged at a light output end of the fourth optical splitter 317 and is configured to receive the first signal laser or the second signal laser output from the fourth optical splitter 317 and transfer the first signal laser or the second signal laser to an emission port of the circulator.

Optionally, each laser transmission and detection channel may also include an angle scanning compensator 312. The angle scanning compensator 312 is configured to receive the first signal laser and the second signal laser from the circulator 318 in a time-division manner, and the TE light of the first signal laser and the TM light of the second signal laser at different periods are emitted at different angles, wherein the emission directions of the TE light and the TM light differ by a preset angle.

Specifically, the angle scanning compensator 312 includes a birefringent device 3123 and a rotating mirror 3121. As shown in FIG. 3E, the birefringent device 3123 is configured to receive the first signal laser and the second signal laser at different time instants. Since the first signal laser and the second signal laser are TE light and TM light in different periods respectively, and the TE light and the TM light have different polarization directions, when the first signal laser and the second signal laser are incident on the birefringent device 3123 at the same incident angles, the first signal laser which is the TE light and the second signal laser which is the TM light are refracted by the birefringent device 3123 with different refractive indexes, so that the angles of the first signal laser and the second signal laser existing the birefringent device 3123 are different. Due to the rotation of the rotating mirror, when the TE light and TM light are projected onto the rotating mirror 3121 at different angles, the rotating mirror can enable the TE light and the TM light to be emitted at substantially the same angle. The birefringent device 3123 can be configured so that the angles at which the TM light and the TE light exit the birefringent device 3123 match the rotation speed of the rotating mirror 3121, so that the TE light and the TM light are reflected by the rotating mirror 3121 at substantially the same angle. For example, the birefringent device 3123 can be a birefringent wedge-shaped block, and the material and the thickness of the birefringent device 3123 can be selected so that the birefringent device 3123 can deflect the TE light by a first angle α and deflect the TM laser by a second angle β, where the angle difference |α−β| can be a preset value, and the preset value can match the rotation speed of the rotating mirror 3121.

Optionally, each laser transmission and detection channel also includes a detection component 33. The detection component 33 is configured to receive the reflected laser beam. The reflected laser beam can be a reflected beam with period T. Referring to FIG. 1 and FIG. 3E, the ascending-frequency duration of the reflected laser beam can be a third reflected laser, and the third reflected laser can be TE light or TM light; the descending-frequency duration of the reflected laser beam can be a fourth reflected laser, and the fourth reflected laser can be TM light or TE light. Specifically, the detection component 33 may receive the reflected laser beam from the circulator 318.

Specifically, the detection component may include a mixer 309 configured to receive the first local oscillation laser or the second local oscillation laser and the reflected laser beam, and cause optical interference between the first local oscillation laser or the second local oscillation laser and the reflected laser to generate a coherent signal. Optionally, the mixing device may be a coupler, such as a 2×2 coupler.

Optionally, the detection component 33 may also include a balanced detector 310. The balanced detector 310 may be configured to receive the output signal of the mixer 309 and detect the beat frequency of the ascending-frequency stage and the beam frequency of the descending-frequency stage according to the output signal, and output detection results. The balanced detector 310 may be, for example, one or more photodetectors.

Optionally, the light detection and ranging system may also include an acquisition and processing device 311. The acquisition and processing device 311 is configured to receive the output of the balanced detector 310, and determine the beat frequencies based on the output, and obtain the distance and/or the speed of the target through calculation.

Couplers, mixers, balanced detectors, photodetectors, and acquisition and processing devices are common devices in the field of FMCW light detection and ranging system, and will not be described in detail here. The acquisition and processing device includes, for example, an acquisition device and a processor. The acquisition can convert the analog signal into a digital signal related to the detection information, such as an analog-to-digital converter. The processor processes the digital signal to determine the distance and the speed of the target relative to the light detection and ranging system. The processor is such as a field programmable gate array (FPGA), a digital signal processor (DSP), etc.

In some embodiments, as shown in FIG. 3A to FIG. 3E, the light detection and ranging system further includes: a lens component 313. The lens assembly 313 is disposed between the circulator 318 and the angle scanning compensator 312 and is configured to collimate the signal laser and focus the reflected laser beam to be coupled into the circulator 318.

In some embodiments, the light detection and ranging system further includes a beam scanning and guide device, and the beam scanning and guide device is disposed between the lens component 313 and the target to achieve deflection and scanning of laser.

The light detection and ranging system provided by the present disclosure can perform angle compensation on the signal laser emitted by the rotating mirror, thereby avoiding the angle mismatch caused by two consecutive signal laser in the ascending-frequency phase and the descending-frequency phase during the rotation of the rotating mirror, and achieving high measurement accuracy. In addition, the solution of the present application only requires one detection component, thereby saving the number of components and reducing the space occupied by the components.

FIG. 3F is a sixth schematic structural diagram of the light detection and ranging system of the present application. The structure of the light detection and ranging system shown in FIG. 3F is similar to the structure of the light detection and ranging system shown in FIG. 3E. The difference between the structures is that the structure of the angle scanning compensator 312 in the light detection and ranging system in the embodiment of FIG. 3F is different from the structure of the angle scanning compensator 312 in the light detection and ranging system in FIG. 3E. Specifically, the angle scanning compensator 312 in FIG. 3F includes a birefringent device 3123 and a rotating mirror 3121. As shown in FIG. 3F, the rotating mirror 3121 is configured to receive the signal laser from the circulator 318 and then project the signal laser onto the birefringent device 3123. The birefringent device 3123 is configured to produce different refractions for TE light and TM light in the signal laser. Due to the rotation of the rotating mirror, the first signal laser and the second signal laser projected by the rotating mirror 3121 onto the birefringent device 3123 has an angle difference caused by the rotation, and this angle difference is the angle mismatch. By configuring the birefringent device 3123, the angles of TE light and TM light exiting from the birefringent device 3123 can be made the same. Specifically, one or more of the material, the thickness, and the refractive index of the birefringent device 3123 may be configured or selected such that TE light and TM light exiting from the birefringent device 3123 at the same angle. The birefringent device 3123 can deflect TE light by a first angle α, and deflect TM light by a second angle β. The angle difference |α−β| can be a preset value, and this preset value can compensate form the angle difference generated by the rotation of the rotating mirror 3121, thereby making the angles of the TE light and the TM light emitted from the birefringent device 3123 basically the same, thereby overcoming the above angle mismatch problem. The operational principles of other devices shown in FIG. 3F are similar to the operational principles of the corresponding devices shown in FIG. 3E. For details of the device, please refer to the relevant description in FIG. 3E above, which will not be described in detail here to save passage.

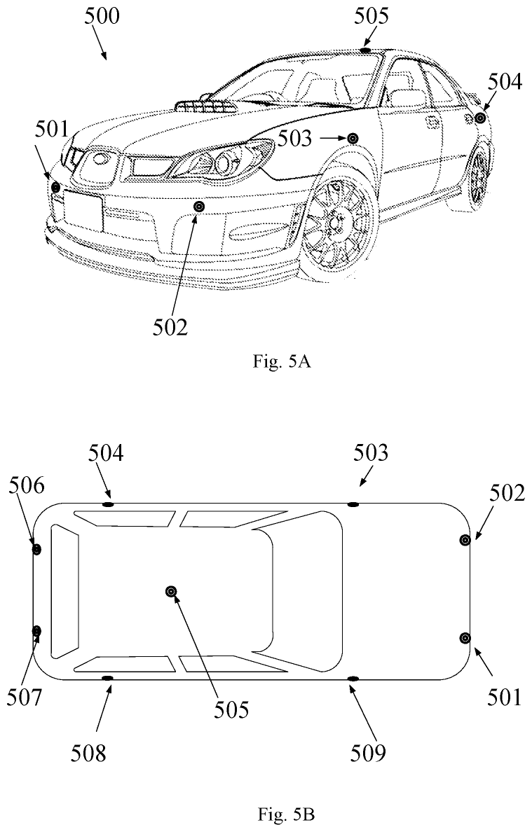

FIG. 5A and FIG. 5B illustrate an example autonomous vehicle 500 according to embodiments of the present application, which may include any of the components of the light detection and ranging system shown in any of FIG. 3A-FIG. 3F of the present application. The illustrated autonomous vehicle 500 includes a sensor array configured to capture information of one or more targets of the autonomous vehicle's external environment and generate sensor data related to the captured information of the one or more targets for use in controlling the operation of the autonomous vehicle 500. FIG. 5 shows sensors 501, 502, 503, 504 and 505. FIG. 5B illustrates sensors 501, 502, 503, 504, 505, 506, 507, 508 and 509. FIG. 5B shows a top view of the autonomous vehicle 500. Any one of sensors 501, 502, 503, 504, 505, 506, 507, 508, and 509 may include the light detection and ranging system shown in any one of FIG. 3A-FIG. 3F of the present application. The light detection and ranging system includes any of the components of any of FIG. 3A-FIG. 3F. The autonomous vehicle may include a powertrain that includes a prime mover powered by an energy source and capable of drive a driveline. The autonomous vehicle may also include control systems including directional control, powertrain control, and braking control. The autonomous vehicle may be implemented as any number of different vehicles, including vehicles capable of transporting people and/or cargo and capable of operating in a variety of different environments. It should be understood that the components described above can vary widely based on the type of vehicles in which they are utilized. For details of this embodiment of the present application, reference may be made to the description of the foregoing embodiment. In order to avoid repetition, the description will not be repeated here in this application.

In the technical solutions of the present application provides an angle scanning compensator, the solution of the present application can solve the angle mismatch problem caused by the rotation of the rotating mirror, so that laser beams can be emitted in basically the same direction. The solution of the present application does not require multiple detection components, thus saving the number of devices and reducing the space occupied by the devices, thus reducing the system size and system cost.

What is claimed is:

1. A light detection and ranging system, comprising:
at least one laser transmission and detection channel,
wherein each of the at least one laser transmission and detection channel comprises:
a laser unit configured to emit a first signal laser and/or a second signal laser, the first signal laser and the second signal laser are frequency modulated lasers, the first signal laser has an ascending-frequency duration, and the second signal laser has a descending-frequency duration, wherein a wavelength of the first signal laser is different from a wavelength of the second signal laser, or a polarization direction of the first signal laser is different from a polarization direction of the second signal laser;
a light emitter configured to emit the first signal laser and/or the second signal laser;
an angle scanning compensator configured to receive the first signal laser and the second signal laser from the light emitter in a time-division manner, and to emit the first signal laser and the second signal laser in a substantially same direction, wherein the first signal laser and the second signal laser are reflected after encountering a target, to generate a first reflected laser and a second reflected laser;
a detection component configured to receive the first reflected laser and the second reflected laser, obtain a first beat frequency signal of the first reflected laser and a second beat frequency signal of the second reflected laser, and output the first beat frequency signal and the second beat frequency signal; and
an acquisition and processing device configured to determine a speed and/or a distance of the target based on the first beat frequency signal and the second beat frequency signal.

2. The light detection and ranging system according to claim 1, wherein the angle scanning compensator comprises a dispersion device, and the wavelength of the first signal laser is different from the wavelength of the second signal laser; or
the angle scanning compensator comprises a birefringent device, and the polarization direction of the first signal laser is different from the polarization direction of the second signal laser.

3. The light detection and ranging system according to claim 2, wherein the angle scanning compensator comprises a rotating mirror;
the dispersion device or the birefringence device enables the first signal laser and the second signal laser to be incident onto the rotating mirror with a first angular deviation, and the rotating mirror enables the first signal laser and the second signal laser be emitted in the substantially same direction, or
the rotating mirror reflects the first signal laser and the second signal laser onto the dispersion device or the birefringence device with a first angle deviation, and the dispersion device or the birefringence device enables the first signal laser and the second signal laser to be emitted in the substantially same direction.

4. The light detection and ranging system according to claim 1, wherein the light emitter includes a first polarization-rotation optical splitter or a circulator.

5. The light detection and ranging system according to claim 3, wherein the laser unit comprises:
a first laser configured to generate a first laser beam having a first wavelength; and
a second laser configured to generate a second laser beam having a second wavelength.

6. The light detection and ranging system according to claim 5, wherein, the laser unit further comprises:
a first optical switch configured to receive the first laser beam and selectively pass or block the first laser beam;
a second optical switch configured to receive the second laser beam and selectively pass or block the second laser beam;
a first multiplexer, connected to the first optical switch and the second optical switch, and configured to multiplex the first laser beam and the second laser beam, and output the first laser beam and the second laser beam in a time-division manner.

7. The light detection and ranging system according to claim 5, wherein, the laser unit further comprises:
a first optical splitter configured to receive the first laser beam and the second laser beam, split the first laser beam into a first component of the first laser beam and a second component of the first laser beam, and split the second laser beam into a first component of the second laser beam and a second component of the second laser beam,
a first phase shifter and a second phase shifter, wherein the first phase shifter is configured to receive the first component of the first laser beam and the first component of the second laser beam, and perform phase-shift of the first component of the first laser beam and the first component of the second laser beam, and the second phase shifter is configured to receive the second component of the first laser beam and the second component of the second laser beam and perform phase-shift of the second component of the first laser beam and the second component of the second laser beam, so that phase difference between the phase-shifted first component of the first laser beam and the phase-shifted second component of the first laser beam is 0 degree and phase difference between the phase-shifted first component of the second laser beam and the phase-shifted second component of the second laser beam is 180 degrees, or the phase difference between the phase-shifted first component of the first laser beam and the phase-shifted second component of the first laser beam is 180 degrees and the phase difference between the phase-shifted first component of the second laser beam and the phase-shifted second component of the second laser beam is 0 degree;
a first combiner configured to receive the phase-shifted first component of the first laser beam and the phase-shifted first component of the second laser beam, and to receive the phase-shifted second component of the first laser beam and the phase-shifted second component of the second laser, wherein when the phase difference between the phase-shifted first component of the first laser beam and the phase-shifted second component of the first laser beam is 0 degree and the phase difference between the phase-shifted first component of the second laser beam and the phase-shifted second component of the second laser beam is 180 degrees, the first combiner outputs the first laser beam; when the phase difference of the phase-shifted first component of the first laser beam and the phase-shifted second component of the first laser beam is 180 degrees and the phase difference between the phase-shifted first component of the second laser beam and the phase-shifted second component of the second laser beam is 0 degree, the first combiner outputs the second laser beam.

8. The light detection and ranging system according to claim 6, wherein each of the at least one laser transmission and detection channel further comprises:
a second optical splitter configured to receive the first laser beam and the second laser beam in a time-division manner, divide the first laser beam into a first signal laser and a first local oscillation laser, and divide the second laser beam into a second signal laser and a second local oscillation laser.

9. The light detection and ranging system according to claim 7, wherein each of the at least one laser transmission and detection channel further comprises:
a second optical splitter configured to receive the first laser beam and the second laser beam in a time-division manner, divide the first laser beam into a first signal laser and a first local oscillation laser, and divide the second laser beam into a second signal laser and a second local oscillation laser.

10. The light detection and ranging system according to claim 3, wherein the laser unit comprises:
a first laser configured to generate a first laser beam having a first wavelength;
a third optical splitter configured to receive the first laser beam and divide the first laser beam into a first laser component and a second laser component,
a first phase shifter configured to receive the first laser component and perform phase-shift of the first laser component;
a second phase shifter configured to receive the second laser component, and perform phase-shift of the second laser component, so that phase difference between the first laser component and the second laser component is 90 degrees or −90 degrees;
a first optical splitter configured to receive the phase-shifted first laser component and the phase-shifted second laser component, and output a first combined laser or a second combined laser, wherein when phase difference between the phase-shifted second laser component and the phase-shifted second laser component is 90 degrees, the first optical splitter outputs the first combined laser; when phase between the phase-shifted first laser component and the phase-shifted second laser component is-90 degrees, the first optical splitter outputs the second combined laser.

11. The light detection and ranging system according to claim 10, wherein each of the at least one laser transmission and detection channel further comprises:
a second polarization-rotation optical splitter configured to maintain a polarization direction of the first combined laser, change a polarization direction of the second combined laser, and output the first combined laser with the polarization direction being unchanged and the second combined laser with the polarization direction being changed.

12. The light detection and ranging system according to claim 11, wherein each of the at least one laser transmission and detection channel further includes:
a fourth optical splitter, arranged at a light emission end of the second polarization-rotation optical splitter, and configured to divide the first combined laser into a first signal laser and a first local oscillation laser, or to divide the second combined laser into a second signal laser and a second local oscillation laser.

13. The light detection and ranging system according to claim 8, wherein the detection component comprises:
a first mixer configured to receive the reflected laser beam and the first local oscillation laser, or to receive the reflected laser beam and the second local oscillation laser, and to mix the reflected laser beam with the first local oscillation laser, or mix the reflected laser beam and the second local oscillation laser;
a balance detector configured to receive output of the first mixer and detect a beat frequency of the ascending-frequency duration and a beat frequency of the descending-frequency duration.

14. The light detection and ranging system according to claim 12, wherein the detection component comprises:
a first mixer configured to receive the reflected laser beam and the first local oscillation laser, or to receive the reflected laser beam and the second local oscillation laser, and to mix the reflected laser beam with the first local oscillation laser, or mix the reflected laser beam and the second local oscillation laser;
a balance detector configured to receive output of the first mixer and detect a beat frequency of the ascending-frequency duration and a beat frequency of the descending-frequency duration.
